(19) United States
(12) Patent Application Publication
(10) Pub. No.: US 2019/0212747 A1
(43) Pub. Date: Jul. 11, 2019

(54) Lane Marker Signal Improvement through Mapped Geo-Referenced Lane Boundaries

(71) Applicant: Continental Automotive Systems, Inc., Auburn Hills, MI (US)

(72) Inventors: Matthew Donald Berkemeier, Beverly Hills, MI (US); Keja Rowe, Southfield, MI (US); Dominik Froehlich, Royal Oak, MI (US); Andre Payant, Rochester Hills, MI (US); Graham Fletcher, Auburn Hills, MI (US); Steffen Hartmann, Royal Oak, MI (US); Ibro Muharemovic, Shelby Township, MI (US)

(73) Assignee: Continental Automotive Systems, Inc., Auburn Hills, MI (US)

(21) Appl. No.: 16/115,071

(22) Filed: Aug. 28, 2018

Related U.S. Application Data
(60) Provisional application No. 62/552,237, filed on Aug. 30, 2017.

(51) Int. Cl. G05D 1/02; B62D 6/00

(52) U.S. Cl. CPC G05D 1/0212; G05D 1/0278; G05D 1/0274; G05D 2201/0213; G05D 1/0257; G05D 1/0251; B62D 6/002; G05D 1/0234

(57) ABSTRACT

A method and apparatus for aligning a vehicle to roadway lane markers includes measuring at least one of a first distance between the vehicle and lane markers for the roadway and a second distance between the vehicle and a recognizable object proximate to the roadway. The location of the vehicle is determined from a satellite navigation system receiver. This location is combined with the first and/or second distances to provide a localization of the vehicle on a high definition (“HD”) map of the roadway. A steering correction signal is generated in response to the comparison of the first distance to the localization of the vehicle on the HD map. The method further includes providing the steering correction signal to an electronic steering controller, wherein the electronic steering controller causes a vehicle steering mechanism to change the position of the vehicle in the roadway lane.

### CROSS REFERENCE TO RELATED APPLICATION

This application claims the benefit of provisional patent application No. 62/552,237, filed Aug. 30, 2017, which is hereby incorporated by reference.

### TECHNICAL FIELD

The technical field relates generally to autonomous vehicles and more particularly to a method and apparatus for aligning a vehicle to roadway markers.

### BACKGROUND

Automobile drivers on a road or highway use lane markings or stripes, often made from white or yellow paint, to identify lanes and as well as keep the vehicle centered in a particular lane. Automated or machine-controlled lane detection methods and lane centering methods using painted lane markings are known. In lane detection, a camera mounted on a vehicle detects the lane markings on a road surface and determines their positions on the road relative to the vehicle. Lane centering systems automatically steer a vehicle to keep the vehicle centered within a lane.

Prior art lane detection and lane centering systems and methods are prone to failure or become inaccurate when lane markings are either missing, partially obliterated, faded or are covered as often happens during the winter. Similarly, when lane markings are omitted, as happens on new road surfaces or at on- and off-ramps, prior art lane centering and lane detection systems cannot distinguish or identify where a lane is located. Moreover, lane markings are sometimes added temporarily in a construction zone.

As such, it is desirable to present a method and apparatus for improving lane detection and lane centering. In addition, other desirable features and characteristics will become apparent from the subsequent summary and detailed description, and the appended claims, taken in conjunction with the accompanying drawings and this background.

### BRIEF SUMMARY

In one exemplary embodiment, a method of aligning a vehicle to roadway lane markers includes measuring at least one of a first distance between the vehicle and lane markers for the roadway and a second distance between the vehicle and a recognizable object proximate to the roadway. The method also includes determining the location of the vehicle from a satellite navigation system receiver. The method further includes combining the location of the vehicle as determined from the satellite navigation system receiver with at least one of the first and second distances to provide a localization of the vehicle on a high definition (“HD”) map of the roadway. The method also includes generating a steering correction signal responsive to a comparison of the first distance to the localization of the vehicle on the HD map. The method further includes providing the steering correction signal to an electronic steering controller, wherein the electronic steering controller causes a vehicle steering mechanism to change the position of the vehicle in the roadway lane.

In one exemplary embodiment, an apparatus to align a vehicle to lane markers of a roadway includes a camera. The camera is configured to measure at least one of a first distance between the vehicle and lane markers for the roadway and a second distance between the vehicle and a recognizable object proximate to the roadway. A satellite navigation system receiver is configured to determine the location of the vehicle. A processor is operatively coupled to the camera and the satellite navigation system receiver. The processor is configured to receive the first and second distances from the camera, receive the satellite navigation system receiver-determined location and combine the location of the vehicle as determined from the satellite navigation system receiver with at least one of the first and second distances and provide a localization of the vehicle on a high definition (“HD”) map of the roadway. An electronic steering controller is coupled to the processor. The electronic steering controller is configured to causes a vehicle steering mechanism to change the position of the vehicle in the roadway lane responsive to the location of the vehicle as determined from the satellite navigation system receiver with the first and second distances and localization of the vehicle on the HD map of the roadway.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a flowchart showing a method of aligning a vehicle to roadway lane markers according to one exemplary embodiment;

FIG. 2 is a block diagram showing an apparatus for implementing the method of FIG. 1 according to one exemplary embodiment.

### DETAILED DESCRIPTION

Referring to the Figures, wherein like numerals indicate like parts throughout the several views, a method 100 of aligning a vehicle 300 to roadway lane markers 302 and related apparatus 200 are shown and described herein.

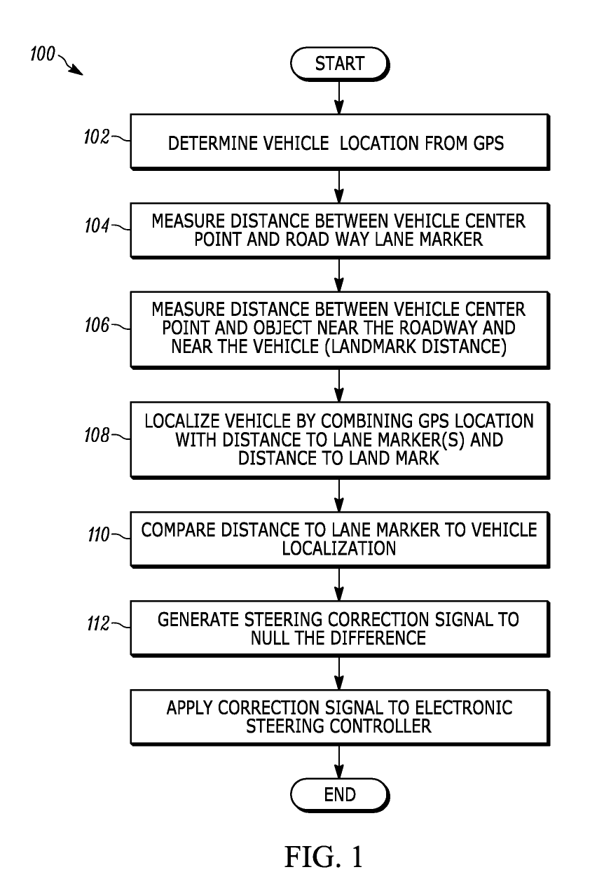

Referring to FIG. 1, the method 100, at 102, includes determining the vehicle's position and/or orientation. In one exemplary embodiment, this determination is performed using a satellite navigation system receiver 208, e.g., a conventional global positioning system (“GPS”) receiver carried by the vehicle 300. For cost-sensitive applications, this may be implemented with only the standard positioning service (“SPS”) with accuracy on the order of several meters. Of course, the receiver 208 may provide other useful information, including, but not limited to, the speed of the vehicle 300.

The method 100 also includes, at 104, measuring a first distance between the vehicle and lane markers 302 for the roadway. Measuring this first distance may be achieved, in one embodiment, by utilizing a camera 202 and/or other sensing device (not shown) to view and/or scan the roadway surface. In the exemplary embodiment, the camera 202 is a stereo camera (not separately numbered). The scanned image produced by the camera 202 may then be analyzed by a processor and, given the position of the camera 202 on the vehicle, the first distance between the vehicle and the lane markers 302 may be calculated, as is appreciated by those skilled in the art. Of course, the first distance may be calculated using a “center line” of the vehicle 300, or using any other point of reference, as appreciated by those skilled in the art.

The camera 202 may also be utilized to determine other aspects of the lane markers 302. These aspects may include the curvature of the lane markers 302 and the curvature rates of the lane markers 302. The camera 202 may further be utilized to determine the yaw of the vehicle 300 with respect to the lane markers 302.

The method 100 may also include, at 106, measuring a second distance between the vehicle 300 and an object 304 proximate to the roadway. The object 304 may include, but is certainly not limited to, a guard rail, a sign, a light pole, a stanchion, a utility tower, and an overpass.

The method 100 may further include, at 108, combining the location of the vehicle 300 as determined from the satellite navigation system receiver with at least one of the first and second distances to provide a localization of the vehicle 300 on a high definition (“HD”) map 210 of the roadway. The HD map 210 may be stored in a database (not separately numbered) or other storage configuration as appreciated by those of ordinary skill in the art. In a highly automated driving (“HAD”) vehicle, the availability of an HD map is important. In some embodiments, a map is stored in a non-volatile memory device operatively coupled to a processor 204 that receives signals from the GPS receiver 208 and the camera 202 and calculates a steering corrections signal there from, as described in greater detail below.

In one exemplary embodiment, the vehicle 300 is located and oriented on the HD map. After the vehicle is located and oriented on the map, a processor 204 calculates where lane markers 302 should be located relative to the vehicle's location and orientation, as is detected by the camera 202 directed at the roadway surface. Detected lane marks 302 are evaluated according to their location, direction, curvature, and curvature rate. The method 100 may also include comparing the map-derived lane marker signals to actual lane marker signals obtained from the camera 202 that is directed at the roadway and receiving images representing the lane markers 302 on the actual lane.

In one exemplary embodiment, an error signal is obtained by comparing map-derived lane marker signals to the actual lane marker signals from the camera 202. The difference between those two locations, i.e., the error between them, is used to adjust the estimate of the vehicle's current position and orientation.

The method 100 may also include evaluating the vehicle's speed, angular velocity, steering angle, acceleration, and/or other motion characteristics parameters either periodically or at random times in order to adjust the calculated position. The method 100 may utilize the instantaneous speed, angular velocity, steering angle, and deceleration or acceleration to recalculate the most recently determine location and thus updates that location using those calculations.

As used herein, the term, “landmark” 304 refers to an object or feature of a landscape that is easily seen and recognized from a distance, especially one that enables someone to establish their location. The method 100 may also use a physical location of a landmark that is detected as being near the vehicle to further refine its position in a lane. When a landmark 304 is detected on a map using the previously estimated position and orientation determined, one or more cameras 202 attached to the vehicle 300 and directed toward landscape around the vehicle 300 “see” the landmark and measure the actual position of the landmark 304, relative to the vehicle 300. A comparison of the map-determined location of the landmark 304 relative to the vehicle 300 versus the measured actual location is performed, the difference of which is used to adjust the vehicle's actual position and direction.

Another potential feature of the method 100 is to periodically check the vehicle's location as determined by the satellite navigation receiver 208. An updated location determination may be made using the position received from the satellite navigation receiver 208. An “expected position” as represented by the most recently-determined location is compared to an actual detected position as provided by a satellite navigation receiver 208. The vehicle's most recently-determined actual location is adjusted by accounting for the latest measurement from the satellite navigation receiver 208.

The method 100 also includes, at 112, generating a steering correction signal responsive to a comparison of one of the measured or calculated distances to the localization of the vehicle 300 on the HD map 210.

At 114 of the method 100, the steering correction signal is provided to an electronic steering controller, e.g., by applying such a signal to the vehicle's CAN bus 213. When the correction signal is provided to an electronic steering controller 212, the vehicle's steering mechanism (not shown) is adjusted to place the vehicle 300 in the center of the lane as determined by the combined locations obtained from the satellite navigation receiver 208 and the distance to the lane marker and/or distance to a landmark on the HD map 210.

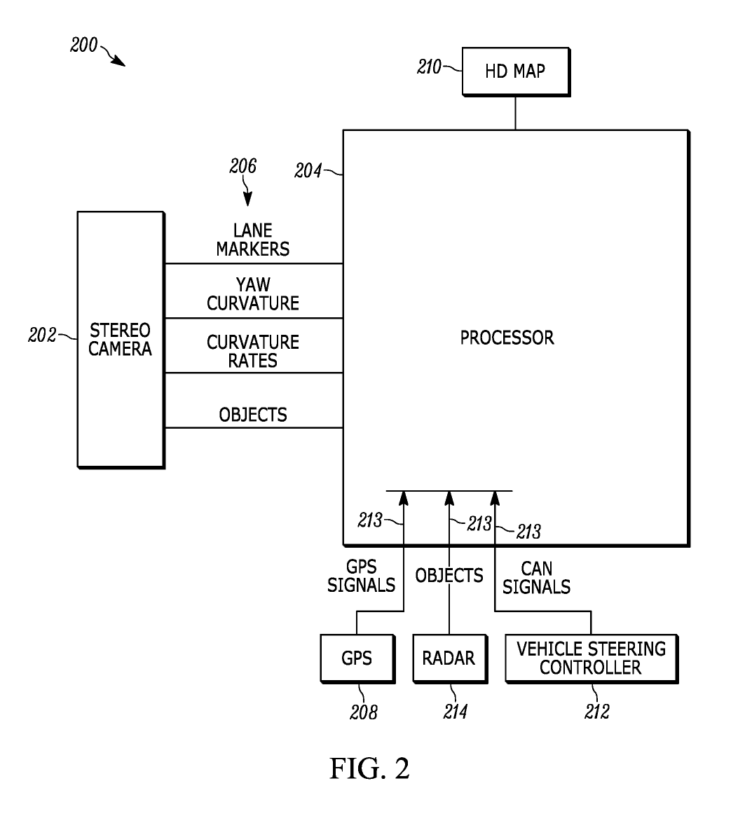

Referring now to FIG. 2, an exemplary apparatus 200 configured to align a vehicle 300 to roadway lane markers 302 and provide a lane marker signal improvement includes at least one camera 202 operatively coupled to a processor 204 through a bus 206. And, as used herein, the bus 206 is considered to be a set of electrically parallel conductors in a computer system that forms a main transmission path between the computer and devices peripheral to it. However, other techniques for communicating between the camera 202 and the processor 204 may be contemplated by those of ordinary skill in the art.

The processor 204 is coupled to a conventional satellite navigation receiver 208 and a non-transitory memory device 210 which stores an HD map.

An electronic steering controller 212 is coupled to the processor 204 through a bus 213, e.g., a vehicle CAN bus 213, and receives signals there from which cause the electronic steering controller to move or adjust the vehicle's steering linkage (not shown, but well known in the art) responsive to signals that the steering controller 212 receives from the processor 204.

In one exemplary embodiment, the stereo camera 202 is configurable or steerable to enable it to view both lane markings and landmarks adjacent the roadway and near the vehicle. In an alternate embodiment, a second camera 202, e.g., a second stereo camera, is directed at the periphery of the vehicle and is essentially dedicated to viewing stationary or fixed objects adjacent the roadway and near the vehicle and which can be located on the HD map. Such an alternate embodiment, i.e., one that uses two cameras provides a faster response time with the additional expense of a second camera.

In another alternate embodiment, the apparatus 200 includes a radar transponder 214 which is configured to measure distances between the vehicle 300 and a guardrail 304 or other fixed objects 304 near the vehicle 300.

Those of ordinary skill in the art should recognize that combining a relatively coarse location obtained from a satellite navigation receiver 208 with locations obtained from a lane marker detection and nearby recognizable objects 304 such as guardrails, speed limit signs, signs noting distances to cities or exits enables a more precise location of the vehicle to be determined on an HD map 210. Precisely locating the vehicle 300 on such a map 210 enables the vehicle 300 to be more precisely positioned in the center of a lane regardless of how the lane markers 302 might be obliterated, deteriorated, or otherwise not readily apparent to the cameras and systems using prior art lane detection and lane centering methods.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of aligning a vehicle to roadway lane markers, the method comprising:
measuring at least one of a first distance between the vehicle and lane markers for the roadway and a second distance between the vehicle and a recognizable object proximate to the roadway;
determining the location of the vehicle from a satellite navigation system receiver;
combining the location of the vehicle as determined from the satellite navigation system receiver with at least one of the first and second distances to provide a localization of the vehicle on a high definition (“HD”) map of the roadway;
generating a steering correction signal responsive to a comparison of the first distance to the localization of the vehicle on the HD map; and
providing the steering correction signal to an electronic steering controller;
wherein the electronic steering controller causes a vehicle steering mechanism to change the position of the vehicle in the roadway lane.

2. The method of claim 1, wherein measuring the first distance comprises scanning the roadway surface for lane markers using a camera and calculating a distance between the vehicle and the lane markers.

3. The method of claim 1, wherein measuring the first distance comprises scanning the roadway surface for lane markers using a camera and measuring curvature of the lane markers.

4. The method of claim 1, wherein measuring the second distance comprises scanning a predetermined area adjacent to the roadway surface for recognizable objects using a camera and calculating a distance between the vehicle and a recognized object.

5. The method of claim 1, wherein measuring the second distance comprises scanning a predetermined area adjacent to the roadway surface for recognizable objects using RADAR and calculating a distance between the vehicle and a recognized object.

6. The method of claim 1, wherein localization of the vehicle comprises estimating the vehicle's position on the HD map using a vehicle model to predict dynamic behavior of the vehicle over a short period of time.

7. The method of claim 6, wherein the vehicle model mathematically describes how the vehicle's position and direction will change in response to a steering angle.

8. The method of claim 1, wherein generating a steering correction signal comprises generating a signal that causes the vehicle to change its position relative to the lane markers while the vehicle is moving.

9. An apparatus to align a vehicle to lane markers of a roadway, the apparatus comprising:
a camera configured to measure at least one of a first distance between the vehicle and lane markers for the roadway and a second distance between the vehicle and a recognizable object proximate to the roadway;
a global positioning system (GPS), configured to determine the location of the vehicle;
a processor, operatively coupled to the camera and the GPS, the processor being configured to:
receive the first and second distances from the camera;
receive the GPS-determined location; and
combine the location of the vehicle as determined from the GPS with at least one of the first and second distances and provide a localization of the vehicle on a high definition (HD) map of the roadway;
an electronic steering controller coupled to the processor, the electronic steering controller configured to causes a vehicle steering mechanism to change the position of the vehicle in the roadway lane responsive to the location of the vehicle as determined from the GPS with the first and second distances and localization of the vehicle on a high definition (HD) map of the roadway.

10. The apparatus of claim 9, wherein the camera is a stereo camera.

11. The apparatus of claim 9, wherein the camera is a RADAR system.

12. The apparatus of claim 9, further comprising a non-transitory memory device operatively coupled to the processor and containing the HD map.\
